(19) United States
(12) Patent Application Publication
(10) Pub. No.: US 2026/0166421 A1
(43) Pub. Date: Jun. 18, 2026

(54) Method and System for Decoupling Computation/Hosting and User Network Connection for Multi-User Online Applications

(71) Applicant: TENCENT AMERICA LLC, Palo Alto, CA (US)

(72) Inventors: Rui CHEN, Foster City, CA (US); Wei LI, Palo Alto, CA (US); Xin ZHANG, Palo Alto, CA (US)

(73) Assignee: TENCENT AMERICA LLC, Palo Alto, CA (US)

(21) Appl. No.: 18/980,896

(22) Filed: Dec. 13, 2024

(51) Int. Cl. A63F 13/358

(52) U.S. Cl. CPC A63F 13/358; A63F 2300/531; A63F 2300/534

(57) ABSTRACT

This disclosure introduces a system architecture/methodology designed to enhance network communication between online applications (e.g., Massive Multiplayer Online (MMO) games) and their users. The disclosed example implementations provide the ability to expand network entry points for online applications beyond their primary hosting service providers. The proposed architecture effectively decouples application hosting from network entry. Such separation enables online applications to leverage the network advantages of various network and computing service providers, irrespective of the hosting environment, thereby improving communication between users and the deployed applications. It further allows application developers to select hosting service providers based on optimal cost, services, and other criteria, without being constrained by network performance considerations. In essence, this offers a flexible and efficient scheme to enhance experience of users of the online applications connected from a diverse set of service providers by optimizing both network performance and hosting capabilities in a decoupled manner.

### FIELD OF THE TECHNOLOGY

This disclosure relates to the field of optimization of multi-user online application hosting and network connection to the online application, and is particularly directed to decoupling computing/hosting from the online application and the network connection of users of the online application.

### BACKGROUND OF THE DISCLOSURE

Online applications may be hosted within a network of a particular service provider. Network performance of access by online application users serviced by other service providers and the network of the hosting service provider of the online application may be largely limited by connection latencies from these other service providers to the hosting service provider. User experience of such online applications thus critically depends on both computing capabilities of the hosting service provider and qualities of the network connection from the users to the online application.

### SUMMARY

This disclosure relates to the field of optimization of multi-user online application hosting and network connection to the online application, and is particularly directed to decoupling computing/hosting from the online application and the network connection of users of the online application.

For example, this disclosure introduces a system architecture and methodology designed to enhance network communication between users or user clients of online applications (e.g., Massive Multiplayer Online (MMO) games) and the online applications. The disclosed example implementations provide ability to expand network entry points for online applications beyond their primary hosting service providers. The proposed architecture effectively decouples application hosting from network entry, allowing for optimization on both fronts. Such separation enables online applications to leverage the network advantages of various network and computing service providers, irrespective of the hosting environment of the online applications, thereby improving communication between users of the applications and the application deployments. In the meanwhile, it allows application developers to select hosting service providers based on optimal cost, services, and other criteria, without being constrained by network performance considerations.

Furthermore, this disclosure outlines an example workflow built upon this application hosting and accessing architecture. Such a workflow encompasses critical processes such as latency probing, entry determination, and dynamic selection of optimal network entry points for accessing the online applications, all of which contribute to realizing the full benefits of the system.

In essence, the example implementations disclosed herein offer a flexible and efficient scheme to enhance experience of users of the online applications connected from a diverse set of service providers by optimizing both network performance and hosting capabilities in a decoupled manner.

In some example implementations, a method for application hosting and network connection is disclosed. The method may include receiving a request from a first communication network for an interactive network connection with an application hosted in a second communication network; selecting, among a plurality of network entry points belonging to the second communication network and one or more third communication networks, an optimal target network entry point for the interactive network connection according to network-probing measurements performed to quantify communication latency between the first communication network and the application in the second communication network via each of the plurality of the network entry points; and establishing the interactive network connection between the first communication network and the application in the second communication network.

In the example implementations above, the first communication network has a network peering relationship with at least one of the third communication networks but has no network peering relationship with the second communication network.

In any one of the example implementations above, selecting the optimal target network entry point additionally takes into consideration peering relationship between the first communication network and the one or more third communication networks and between the first communication network and the second communication network.

In any one of the example implementations above, a private direct traffic routing path is established between each of the one or more third communication networks and the second communication network.

In any one of the example implementations above, the first communication network, the second communication network, and each of the one or more third communication networks are provisioned by separate Internet Service Providers (ISPs).

In any one of the example implementations above, the application comprises a multiplayer interactive game.

In any one of the example implementations above, the method is performed by a game lobby server for the multiplayer interactive game; and the request is initiated from a game client via the first communication network to the game lobby server.

In any one of the example implementations above, the method may further include generating a list of network addresses of the plurality of network entry points based on a requesting network address associated with the game client in the first communication network; communicating the list of the network addresses to the game client for the game client to perform the network-probing measurements; and receiving the network-probing measurements from the game client prior to selecting the optimal target network entry point.

In any one of the example implementations above, the method may further include determining that the game client is not capable of performing the network-probing measurements; and initiating and performing the network-probing measurements from the second communication network to the first communication network.

In any one of the example implementations above, the method may further include, after establishing the interactive network connection, continuing probing the communication latency between the first communication network and the application in the second communication network via the plurality of network entry points to determine whether to switch the interactive network connection between the first communication network and the second communication network to a lower latency network entry point other than the optimal target network entry point.

It is to be understood that the foregoing general descriptions and the following detailed descriptions are merely provided for illustration and explanation purposes and are not intended to limit the coverage scope of this disclosure

### BRIEF DESCRIPTION OF THE DRAWINGS

Accompanying drawings herein are incorporated into a specification and constitute a part of this specification, show embodiments that conform to this application, and are used for describing a principle of this application together with this specification.

FIG. 1 shows an example architecture for hosting an online application by one service provider and access the online application by users of other service providers.

FIG. 2 shows an example architecture for decoupling hosting of an online application and network connections by users of the online application.

FIG. 3 shows a schematic illustration of a computer system in accordance with example embodiments of the disclosure.

### DESCRIPTION OF EMBODIMENTS

The present disclosure will now be described in detail hereinafter with reference to the accompanied drawings, which form a part of the present disclosure, and which show, by way of illustration, specific examples of embodiments or implementations. The present disclosure may, however, be embodied in a variety of different forms and, therefore, the covered or claimed subject matter is intended to be construed as not being limited to any of the embodiments or implementations to be set forth below.

Throughout the disclosure and claims below, terms may have nuanced meanings suggested or implied in context beyond an explicitly stated meaning. Likewise, the phrase “in one embodiment” or “in some embodiments” as used herein does not necessarily refer to the same embodiment or embodiments and the phrase “in another embodiment” or “in other embodiments” as used herein does not necessarily refer to a different embodiment or different embodiments. The phrase “in one implementation” or “in some implementations” as used herein does not necessarily refer to the same implementation or implementations and the phrase “in another implementation” or “in other implementations” as used herein does not necessarily refer to a different implementation or different implementations. It is intended, for example, that claimed subject matter includes combinations of exemplary embodiments or implementations in whole or in part.

In general, terminology may be further understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

This disclosure relates to the field of optimization of multi-user online application hosting and network connection to the online application, and is particularly directed to decoupling computing/hosting the online application from the network connection of users of the online application.

For example, this disclosure introduces a system architecture and methodology designed to enhance network communication between users or user clients of online applications (e.g., Massive Multiplayer Online (MMO) games) and the online applications. The disclosed example implementations provide ability to expand network entry points for online applications beyond their primary hosting service providers. The proposed architecture effectively decouples application hosting from network entry, allowing for optimization on both fronts. Such separation enables online applications to leverage the network advantages of various network and computing service providers, irrespective of the hosting environment of the online applications, thereby improving communication between users of the applications and the application deployments. In the meanwhile, it allows application developers to select hosting service providers based on optimal cost, services, and other criteria, without being constrained by network performance considerations.

Furthermore, this disclosure outlines an example workflow built upon this application hosting and accessing architecture. Such a workflow encompasses critical processes such as latency probing, entry determination, and dynamic selection of optimal network entry points for accessing the online applications, all of which contribute to realizing full benefits of the system.

In essence, these example implementations disclosed herein offer a flexible and efficient scheme to enhance experience of users of the online applications connected from a diverse set of service providers by optimizing both network performance and hosting capabilities in a decoupled manner

By way of introduction of the Internet, various network connection and/or data/application hosting services may be provided by Internet Service Providers (ISPs). Each ISP may maintain, provision, and optimize its own communication network and computing resources/capabilities. A network maintained and provisioned by an ISP may be referred to as an ISP network. Such an ISP network may be deployed locally or globally. Multiple ISP networks may be interconnected directly or indirectly to form the Internet. A user of the Internet may obtain network connections to and/or data/application hosting services from an Internet Service Provider (ISP). Generally, an internet user may be broadly embodied as an internal user network and is thus alternatively referred to as a user network. User networks may be of various scales. For example, a user network may only include an individual device connected to its ISP (e.g., a cell phone connected to a cellular wireless service provider). For another example, a user network may be a typical small residential network. For yet another example, a user network may be a large-scale enterprise network. An internet user or user network, regardless of its scale, when being served by an ISP, may be provided with a network connection or entry to the communication network maintained and provisioned by the ISP, and is thereby connected to other networks (other ISPs and other users served by the ISPs) interconnected with the ISP in the Internet.

The term ISP is used in this disclosure to refer to any service providers that provide network connection and/or data/application hosting services. For example, an ISP may only provide network connection service between a user of a limited geographical region and the Internet. For another example, an ISP may only provide data/application hosting/computing services. For yet another example, an ISP may provide both network connection services and data/application hosting/computing services within its ISP network. An internet user may use a combination of ISPs to satisfy its needs for network connection and data/application hosting/computing.

The interconnection between the ISPs may be coordinated and implemented in various manners. For example, a peering relationship may be established between one ISP and another ISP. ISP peering may represent a crucial relationship where two or more ISPs mutually agree to provide access to each other's customers through their respective ISP networks. In such a peering arrangement, the ISPs may implement peering connections that enable exchange of routes of their downstream customers (users), without visibility into each other's upstream routes over the peering connection. Such a reciprocal agreement allows the ISPs to exchange traffic solely between their endpoints and those within their customers' networks.

For another example, the interconnection between the ISPs may be achieved via provider of IP transit services. The peering arrangement above differs significantly from IP transits in that an IP transit provider offers routes to the entire Internet, including those of downstream partners, other ISP peers, and upstream partners. A key advantage of peering lies in its ability to reduce latency. Traffic flowing directly between ISP peers experiences lower latency compared to traffic that must first traverse an intermediary network, such as that of a transit provider.

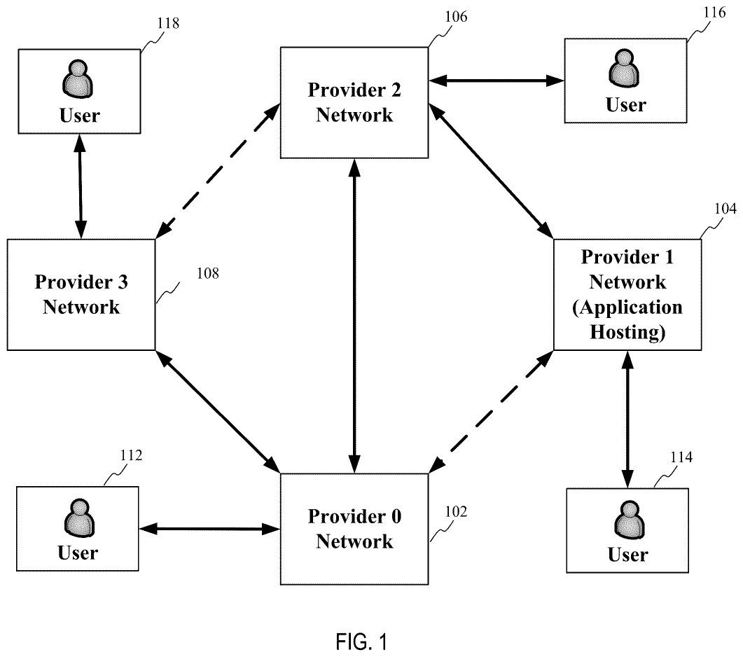

FIG. 1 illustrates an example interconnection between several ISP networks, including networks 102, 104, 106, and 108 managed and provisioned by internet service providers 0, 1, 2, and 3, respectively. In the example of FIG. 1, direct interconnections between the Provider 0 and provider 2, between Provider 0 and Provider 3, and between Provider 2 and Provider 1 are provided via peering arrangement, as indicated by the solid-arrowed lines, whereas IP transit interconnections via other transit providers (not shown) between Provider 2 and Provider 3 and between Provider 0 and Provider 1 are may be arranged, as indicated by the dashed lines with arrows. Provider 1 and Provider 3 in the example of FIG. 1 may be considered as being inter-connected via other ISPs (such as Provider 2 and provider 0) and such connection may be via multiple peering connections or a combination of peering connection and IP transit connections. Such indirect connections may generally be considered as being implemented via IP transit. Similarly, there may be multiple connection paths between Provider 2 and Provider 3, including, for example, the connection path via IP transit represented by the dashed arrowed lines therebetween, and the connection path involving a sequence of peering connections via Provider 0, as shown in FIG. 1.

Each of the ISPs of FIG. 1 may or may not provide communication connection services to end users or user networks. Merely as an example, each of the Providers 0, 1, 2, and 3 are shown in FIG. 1 as being configured to provide Internet connection services to end users. For example, each of Provider 0 (102), Provider 1 (104), Provider 2 (106), and Provider 3 (108) may be configured to provide Internet connection services to one or more end users, such as residential households, enterprises, and the like. Example users or user networks are indicated as 112, 114, 116, and 118 in FIG. 1. While each of the Providers 0, 1, 2, and 3 are indicated as being providing network connections one user in FIG. 1, they usually are deployed and configured to provide network connection services to a large number of end users.

Further, each of the ISPs of FIG. 1 may or may not provide data storage, data/application hosting, computing, and other services to users. For example, Provider 1 (104) of FIG. 1, in addition to providing Internet connection service, is indicated in FIG. 1 as being also configured to further provide application hosting services where an application developed by a developer may be uploaded and hosted by Provider 1, whereas Providers 0, 2 and 3 are indicated as not being configured to provide application hosting services. The application may be run in Provider 1's network and may be subscribed to, accessed and used by other end users that may be directly or indirectly connected to Provider 1's network (such as users 112, 114, 116, and 118). Thus, in the example of FIG. 1, Provider 1 may also provide computing services and resources for the hosting/running of the application. The application developer may use any one of the Providers 0, 1, 2, or 3, or any other ISP not shown in FIG. 1 for its Internet Connection service. In other words, the ISPs providing network connection for the application developer and/or the application users/subscribers may or may not be the ISP that hosts the application. For example, the developer of the application may choose any ISP for network connection to the Internet and any ISP for hosting the application it develops (e.g., Provider 1 as shown in FIG. 1). While the application as developed by the developer and hosted in Provider 1's network may be accessed, subscribed to, and used by other users, such as users 112, 114, 116, and 118, these users may or may not use the ISP associated with the developer or the ISP for hosting the application as their ISP for Internet connection service (e.g., as shown in FIG. 1, user 112 and user 118 may use Provider 0 and Provider 3 as their Internet connection service providers, respectively, whereas user 114 may use Provider 1 as its Internet connection service provider and user 116 may use Provider 2 as its Internet connection service provider).

An ISP as described above may be configured to provide any one or any combination of internet connection service, data hosting service, application hosting service, storage service, and the like. The data hosting services, application hosting services, storage services, and the like may be alternatively referred to as cloud services, encompassing cloud storage services, cloud hosting services, and/or cloud computing services.

In some implementations, for any of the users 112, 114, 116, and 118 to access a particular data/application service within, e.g., Provider 1's network, a unique network address (e.g., IP Address) may be provided by the hosting ISP for this data/application service. Communication sessions may be established between user 112, 114, 116, and/or 118 as one end point and the data/application server in the network of the hosting ISP as the other end point. Communication traffic may be routed between the two end points between the ISP of the user 112, 114, 116, or 118 and the data/application server.

As one specific example, the application described above may be a multi-participant application. Any one or more of users 112, 114, 116, and 118 may be participants of the multi-participant application. For a specific example, the multi-participant application may be a multiplayer online game, such as a Massive Multiplayer Online (MMO) game and the anyone or more of users 112, 114, 116, and 118 may participate in a single or multiple sessions of the multiplayer online game, which may be hosted by one of the ISP networks of FIG. 1, e.g., Provider 1's network.

In these applications hosted by one or more ISPs, multiple participants/players may join from diverse locations via their respective ISP connection networks. The multiple participants/players may request and access an application session (e.g., an MMO game session) and interact with one another from application clients communicating with the application session managed by application hosting servers via network connections. Most computation and information processing involved in such an application may be performed by the application server (e.g., belonging to Provider 1's network in FIG. 1). The game clients may be responsible for receiving requests and commands from the participants/players, communicating such requests and commands to the application server(s), and receiving information from the application server(s) and updating interactive user interfaces at the application clients.

In the context of online gaming, and particularly for online games that involve participation and fast interactions of multiple players, such as in MMO games, network performance becomes very critical for gaming experience. Critical network performance may include, for example, sufficiently large network bandwidth and sufficiently small network latency or jitter. Certain genres of online games, such as those involving Virtual Reality (VR) and First-Person Shooter (FPS) games, are exceptionally sensitive to network latency and jitter. Network latencies may be closely tied to network paths for the communication between the gamers or the game clients and the game hosting servers (or the game deployments). In practice, the network path between gamers and game deployments through one or more ISPs can be highly dynamic and can be influenced by numerous factors.

In general (although not always being the case), a network path that involves only the game hosting ISP (e.g., the hosting ISP and the ISP providing Internet connection service to the gamer are the same ISP) may have less latency than a network path that involves ISPs with peering arrangement/relationship (e.g., the game hosting ISP and the ISP providing Internet connection service to the gamer are different but have peering relationship and arrangement therebetween), which may have less network latency than a network path that involves one or more IP transits (e.g., the game hosting ISP and the ISP providing internet connection service to the gamer are connected via at least one IP transit).

In some example implementations, one or more network entry points in the form of, for example, one or more public IP addresses, may be configured/provided by the game hosting ISP for the game participants to access game sessions running in the game in the network of the hosting ISP. In some further implementations, one or more game management servers may be provisioned. Such servers may run a game management process, which may be referred to as a game lobby. The game management servers running the game lobby may be provided by the game hosting ISP within its network or alternatively by some other ISP.

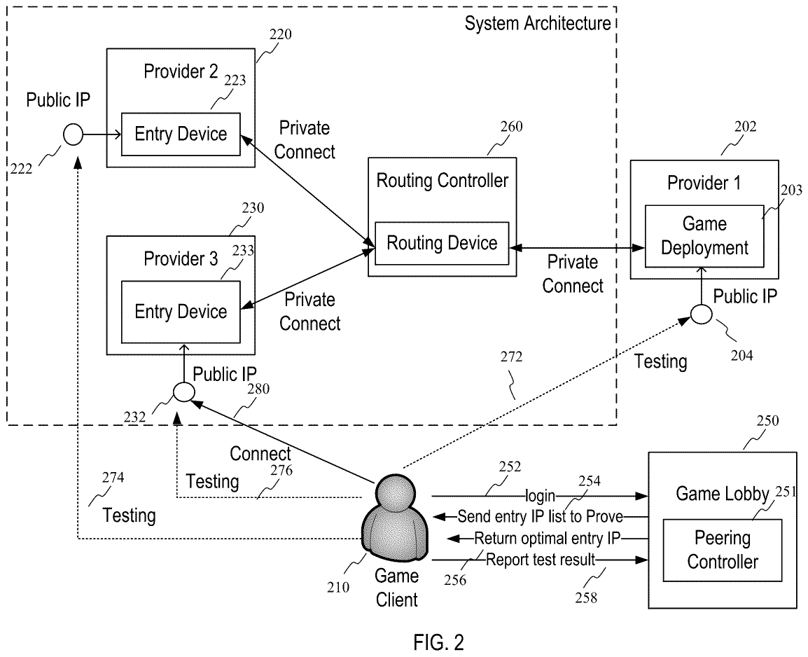

An example of game lobby is illustrated in the specific example implementations in relation to FIG. 2 described in further detail below, but the functions and principles underlying a game lobby described below is generally applicable in other implementations. The game lobby may be accessed by the gamers when requesting to initiate and/or login to a game session. The game lobby communicates with the game hosting servers to manage the game sessions running on the hosting servers. The game lobby further assigns a network entry point among the one or more network entry points to a game client upon login. The game client may then be able to participate in a game session via the assigned network entry point (e.g., in the form of an IP address).

In some example implementations, the one or more network entry points above may all be associated with the game hosting ISP. As such, the network connection from any of the game clients must go through one of these network entry points. While the hosting ISP may have internal control over the optimization of the network latency and connection bandwidth between these network entry points and the game hosting servers, it can only receive user traffic and provide service through these network entry points but may not independently enhance network communication beyond the peering capabilities with various ISPs (that is, the game hosting ISP may not have control over the network path and associated network latency and communication bandwidth between the game clients and these network entry points beyond the peering relationship/arrangement and capabilities with other ISPs). Because the game hosting ISP may not have peering relationship with all ISPs from which the gamers are connected from, game experience of some gamers across different ISPs and/or geographic locations may not be ensured and may be hindered by excessive network latencies.

In the example implementations above, the game developer may choose a hosting ISP for a game, and the network performance and game experience may then depend on the chose hosting ISP, which may not have good peering with all ISPs for current and potential gamer. In addition, as the hosting ISP only provides access to the games via these public IP entry points, such IP entry points represent a single point of failure. Service disruption associated with these single-ISP network entry points would significantly impact gamer experience or may even cause a total loss of service.

One example manner to provide diversity of network entry points is to develop multi-provider platform or infrastructure where a game may be hosted by multiple ISPs, and where public IP entry points of the multiple ISPs may be provided to the game clients. However, such coordinated game hosting is challenge because deployments in different ISPs are usually not managed and optimized together and the service's network capability in one ISP is still restricted by the ISP of a designated public IP entry point.

In the further disclosure below, example implementations are described for expanding public IP entry points of a game hosted on a particular ISP to an additional plurality of diverse set ISPs. These additional ISPs may have their distinct ISP peering capabilities with an even larger set of ISPs beyond the peering relationship of the hosting ISP, thereby offering differentiated performance metrics (latency and jitter) when handling traffic of game clients from various ISPs.

With the above diversity of network entry points, such implementations provide flexibility to optimize entry point selection for a particular game client by, for example, conducting comprehensive network performance analysis through bidirectional speed tests, collecting critical connection metrics between the diverse service provider entry points and players, and selecting an optimal or near optimal network entry point for the particular game client. The diversification of network entry point thus may leverage a data-driven approach that enables the identification and selection of the optimal network entry point for each game client and in each user scenario.

The example implementations described in detail below further provide dynamic client routing by establishing an interaction protocol between game clients and backend game hosting servers in the hosting ISP. Such a protocol may be optimized and updated to empower the backend to dynamically instruct game clients to connect via the most efficient network entry point among the diverse set of network entry points not limited to the hosting ISP, thereby providing opportunities for achieving optimal or near optimal performance during participation (including both initial entry and thereafter) of the game clients based on real-time network conditions of the various ISPs.

The example implementations described in detail below further provides an adaptive network entry point scheme that enables flexibility in scaling of the network entry points without compromising the integrity of the existing deployments of the games with particular ISPs. The approach described herein thus decouples network connection routing optimization and game hosting in a plurality of ISAs and minimizes architecture intrusion while maximizing adaptability to network demands.

In such example implementations, the communication traffic from an expanded IP entry point to the game hosting ISP may be handled by dedicated low-latency and/or low-jitter private connections.

These various example implementations described in the disclosure below focus on Internet services related to network connection, hosting, and computing of multiplayer online games. However, the principles underlying these implementations are not so limited and are broadly applicable to internet services involving network connection, hosting, and computing of any multi-actor online applications wherein optimization of network performances such as latency and jitter are critical and wherein the decoupling of the application hosting and network connection/routing may be advantageous.

FIG. 2 illustrates an example scheme 200 for diversifying network entry points for game clients among a plurality of ISPs rather than only through network entry points associated with the hosting ISP.

As shown in FIG. 2, a game developer may choose to use Provider 1 (202) for hosting an online game. As such, the online game may be deployed by and hosted and run in one or more game servers of Provider 1, as shown by 203. The game servers may be centralized or distributed within the network of Provider 1. Alternatively, Provider 1 may use cloud storage/computing services from another service provider to which it may have low latency connections. The network maintained and provisioned by Provider 1 may be centralized or distributed. For example, the computing resources and network nodes of Provider 1 may be distributed over geographical regions of any scale, in the form of a local, regional, national, or global network. Provider 1 thus may have autonomy in optimizing its network for routing communication traffics that passe through its network or for directing communication traffics targeting end points within its network.

Provider 1 may configure one or more public IP network entry points 204 with, for example, unique IP addresses (only one example public network entry point 204 is shown in FIG. 2). Such network entry points may be associated with network nodes distributed across its network. Such network entry points may be configured for accessing a particular application, such as the online game 203 deployed in the game servers of its network.

Provider 1 may have network peering relationship or arrangement with one or more other ISPs (not shown in FIG. 2), such that communication of game clients from these other ISPs to the network of Provider 1, e.g., to the public IP entry point 204 for the online game 203, may have relatively low network latency and/or jitter.

As further shown in FIG. 2, direct private and low latency interconnections may be established between Provider 1 and one or more other ISPs, e.g., Provider 2 (shown as 220) and provider 3 (shown as 230). For example, dedicated communication channels may be provided for communication traffic from Provider 2 or Provider 3 to Provider 1 without being affected by, or shared with other traffic, thereby ensuring low latency and low jitter interconnections. In some implementations, another service provider may provide such private connection implemented by dedicated communication and routing circuitry and resources, as shown by 260 of FIG. 2.

Collaboration between Provider 1 and Provider 2 and/or provider 3 may be established such that additional public IP network entry points for each of the networks of Provider 2 and Provider 3 may be configured for the access of the online game 203 deployed in Provider 1's network. These Public IP entry points are shown as 222 and 232 for Provider 2 and provider 3, respectively. Multiple such public IP entry points may be configured and may be distributed throughout the networks of Provider 2 and Provider 3. Within each of the networks of Provider 2 and Provider 3, such public IP entry points may be implemented as entry device nodes shown in FIG. 2 as 223 and 233, which connects to game servers in Provider 1 via the private connections described above.

As further shown in FIG. 2, a game client 210 thus may access the game servers in the network of Provider 1 and participate in an online session of the game deployed in Provider 1's network via any one of the public IP entry points 204, 222, and 232, rathe rather than having to connect via the IP network entry points 204 belonging to the network of Provider 1 where the game is deployed.

Such an example scheme of FIG. 2 provides a game access with reduced over all network latency and jitter by game clients originated from a diverse set of ISPs. For example, the game client 210 may reside in an origin ISP network for its user that has no peering relationship or arrangement with Provider 1. As such, accessing the game via the public IP entry point 204 associated with Provider 1 from the origin ISP network may suffer from significant network latencies. On the other hand, the original ISP of the game client 210 may have a peering relationship or arrangement with Provider 3, as such connection between the game client 210 and the public IP entry point 232 may be of low latency. Further because of the low-latency connection between Prover 2's network and Provider 1's network over the private connections shown in FIG. 2, the overall network latency from the game client 210 in the original ISP network via public IP entry point 232, the private connection between Provider 3 and Provider 1, to the game 203 deployed in Provider 1's network may be much lower than that for a connection from the origin ISP network via the public IP entry point 204 to the game 203 deployed in Provider 1's network.

As such, selections may be made as to which public IP network entry point to use for each game client (210 of FIG. 2 being one example game client) to connect to the game servers in Provider 1 (202). Such selections may be made with a goal of optimizing network connection performance for each of the game clients 210 and/or for an aggregation of the plurality of game clients. For example, a first set of metrics for network performance of individual game client may be formulated or predefined. Additionally or alternatively, a second set of metrics for an overall network performance of connections for all game clients may be formulated or predefined. Optimization of the selection of public IP entry points for the game clients may be based on either one of or both of the first and second sets of metrics. Individual game clients may be tiered with different level of target gaming experiences and thus may be associated with different network performance target metrics.

As further shown in FIG. 2, in some example implementations, the selection of public IP network entry points for the various game clients may be determined, controlled, and provisioned by a game lobby 250. As described above, the game lobby 250 may be accessed by the game clients when requesting to initiate and/or login to a game session. The game lobby communicates with the game hosting servers to manage the game sessions running on the hosting servers. The game lobby may further perform the selection and assignment of a public IP network entry point among the one or more public IP network entry points to each game client upon login.

For example, the selectin of public IP entry points may be determined based on performing a set of network performance probing or testing. In some example implementations as shown in FIG. 2, the game client 210 may first send a login request 252 to the game lobby 250 for requesting participation in a game session. The game lobby 250 may then determine whether the game client is capable of carrying out network performance probing/testing.

When the game lobby 250 determines that game client 210 is capable of performing such network performance probing/testing, it may then determine a list of IP addresses for network entry points for accessing the game server, and send the list of IP address to the game client 210 as shown by 254 of FIG. 2. The list of IP addresses, for example, may correspond to public IP entry points of ISPs that have peering relationship/arrangement with the ISP for the game client 210 and or public IP entry points that are geographically close to the game client. Any algorithms or criteria may be used for the game lobby 250 to generate the list of IP address that may potentially provide the game client 210 with a low latency network connection to the game server in Provider 1's network. The game client, upon receiving the list of IP addresses, may initiated network performance probing and testing with respect to connections through the list of IP addresses corresponding to a set of public IP network entry points to the game server, as shown by 272, 274 and 276. The network performance probing/testing, for example, may involve the game client 210 transmitting testing signal or data targeting the game server and receiving acknowledgement information from the game server in order to measure network transmission latency and/or jitter. The testing signal or data and/or the acknowledgement may be timestamped for the purposes of measuring network transmission latency and/or jitter. The probing/testing results may be provided from the game client 210 to the game lobby 250, as shown by 256.

Alternatively, when the game lobby 250 determines that the game client 210 is not capable of initiating and performing network probing/testing, the game lobby 250 may instruct the provider 202, e.g., the game servers, to initiate a network probing/testing towards the claim client 210. The probing/testing results so measured by provider 1 may be provided to the game lobby 250.

In either of the two scenarios above, the game lobby may then determine a selection, among the list of IP addresses, of a target IP address corresponding to a target public IP entry point. The selection, for example, may be determined by picking the target public IP entry point having the best network performance (e.g., lowest network latency and/or network jitter). In some example implementations, the selection may further take into consideration impact of network connections for other game clients in order to optimize network access performance by all game clients participating in the current game session or game clients participating in other game sessions of the current game or in other games hosted by Provider 1 (202). The selected target IP addresses may be provided to the game client 210, as shown by 258. The game client may then connect to the game server in Provider 1's network via the selected public IP entry point, as shown by 280.

As described in the example above, the network performance probing and detection between the game client 210 and the game server in Provider 1's network via the list of IP addresses may be performed in either uplink direction (e.g., for probing unidirectional network latency from the game client 210 to the game server in Provider 1's network) or downlink direction (for probing unidirectional network latency from the game server in Provider 1's network to the game client 210), or in both directions (e.g., for probing bi-directional network latency).

The various steps above, particularly steps 254, 256, and 258, may be performed by a peering controller 251 of the game lobby 250.

The example public IP network entry point selection scheme above may be performed beyond an initial login and access of the game servers by a game client. The network performance may be probed and monitored continuously, periodically, randomly, or at any other timing schemes during the participating of the game client in a game session. A set of switching conditions for network performance may be predefined. The network performance with respect the game traffic associated with the game client may be probed and monitored according to the timing scheme and compared to the switching conditions. If the switching conditions are met (e.g., the network performance of the current connection falls below a set of network performance threshold), the game lobby 250 may then perform or request the game client 210 to perform further testing to identify a better public IP entry point for the claim client to switch to. Alternatively, the list of public IP entry points above for the game client 210 may be monitored according to the time scheme above to determine whether another public IP entry point has become better than the current connecting public IP entry point (e.g., by a predetermined amount) in terms of network performance (e.g., communication latency and/or jitter). In some example implementations, the switching of the public IP entry points for the game client 210 may only be made at a time scale that is sufficiently long (e.g., a predetermined minimum dwell time for a particular connection, so as to avoid frequent switching of the entry points and a ping-pong effect).

As such, the public IP network entry point selection scheme of FIG. 2 may be performed dynamically, in real time or at an appropriate/configurable time scale in order to improve gaming experience of a particular game client or all game clients participating in a game session or all or a subset of the games hosted by Provider 1.

The public IP network entry point selection scheme of FIG. 2 above further provides a decoupling of network connection for game clients and the hosting of the game for the game developer. Rather than only providing IP network entry points associated with the hosting ISP, where optimization for both the network connection (e.g., peering arrangement by the hosting ISP with other ISPs) and the hosting of the game (e.g., internal network performance and computation optimization) falls on the hosting ISP, the example scheme above provided in FIG. 2 decouples the network connection optimization and the game hosting. The game developer thus can choose an ISP for game hosting based on the ISP's internal networking and computation capabilities without concerning too much about the diverse set of ISPs that the game clients may be connected from. The connections of the game clients can be optimized and selected by the game lobby as a result of the arrangement of the private connections between the hosting ISP and other ISPs, and the diverse set of public IP entry points, and as a result of leveraging additional peering relationships between ISPs other than the hosting ISP.

In other words, the example implementations above in FIG. 2 further provide an adaptive network entry point scheme that enables flexibility in scaling of the network entry points without compromising the integrity of the existing deployments of the games with particular ISPs. The approach described herein thus decouples network connection routing optimization and game hosting in a plurality of ISAs and minimizes architecture intrusion while maximizing adaptability to network demands.

As such, the networking and game hosting architecture of FIG. 2 above provides an example manner for extending network entry to extra service providers. In the extra service provider, an entry device with public IP may be placed. Incoming connection may be received from this device and forward to backend. The extra providers may be connected to a central routing device which may route the connection from extra providers to the provider where the game is deployed. The central routing device may be configured to assure systematics of connections coming from the extra providers (providers 2 and 3 in FIG. 2). That is, for same connection the outgoing packet should go through the same entry point as the incoming packet.

Further, as described above, the connection between components of the diverse set of ISPs may leverage private connection such as dedicated communication lines which may not be subject to impact of public internet which may otherwise introduce extra latency compared to dedicated/private connection to the hosting provider. In order to provide optimal selection from the expanded network entry points, the extra latency may be measured and counted into the calculation for the selection. Such dedicated connection may be achieved with network vendors like Equinix which provides private connection with a diverse collection of cloud or hosting vendors with data centers and other network facilities that may be located with close geographic proximity.

Further, as described above, to decide the optimal entry point, the game hosting ISP may determine which ISP network the game client is in and additionally determine the network connection quality details to each of the expanded entry point. For a latency sensitive MMO game, such determination may be made by the game lobby. The game lobby may perform login process and a match making process for the game. Ideally, a game client may have a network probing capability which can be directed by game backend to test connection quality of desired IP addresses and report back to game. If that is the case, and as described in further detail above, the probing process may be included in the game client interaction with game lobby. The test result can be considered in the match making to achieve desired gamer experience. As further described above, in the case of game client not having the network probing capability or when the game lobby is not able to direct the game client to run the test, the game server can use reverse testing data to decide the optimal entry point for the game client. The reverse probing may be tested from the entry provider to the game client IP to collect the network quality data to assist entry point selection. Reverse testing can be done separately and periodically which can simplify the process with prebuilt data.

The advantage of the example scheme above may be achieved in the example ISP deployment scenario illustrated below in Table 1. In Table 1, numbers of peering ISPs with Providers 1 through Provider 4 covering various geographic regions are indicated.

TABLE 1

| Country/Geographic | | | | |
|---|---|---|---|---|
| Regions | Provider 3 | Provider 1 | Provider 2 | Provider 4 |
| Argentina | 410 | 46 | 11 | 0 |
| Brazil | 2117 | 197 | 466 | 520 |
| Chile | 50 | 43 | 7 | 0 |
| Colombia | 92 | 13 | 77 | 0 |
| Peru | 40 | 7 | 4 | 0 |
| Uruguary | 11 | 1 | 1 | 0 |
| Venezuela | 69 | 18 | 43 | 0 |
| SUM | 2789 | 325 | 609 | 520 |

Table 1 shows that Provider 3 has the largest number of peering ISPs. With the example scheme described above, and if dedicated connections between these providers are established with a diverse set of network entry points configured among these providers, the developer of an MMO game may not need to be overly concerned about gaming experience of his/her game clients. For example, the game developer may choose to deploy the MMO game with Provider 3 to take advantage of its large number of peering ISPs (such that the game clients connecting from these peering ISPs would enjoy low network latency), and at the same time need not to worry about game clients connected from the other ISPs that have peering relationship with Provider 1, 2 or 3 but do not have peering relationship with Provider 3 because these game clients may still enjoy low latency connection with Provider 3 via the dedicated private connection from Provider 1, 2, or 4 to Provider 3. Likewise, The game developer may choose to deploy the game with Provider 1, or 2, or 4 if they provide better computation/hosting service, knowing that a large number of game clients from the peering ISPs of Provider 3 can still make a low latency connection to the game via entry points of Provider 3 due to the dedicated connection from Provider 3 to Provider 1, 2, or 4 where the game is hosted.

To summarize, the example implementations above provide at least the following technological improvements:

Enhance Service Resilience: With multiple entrances, if one service provider's entrance encounters issues or performance degradation, player traffic can be quickly redirected to a new entrance, minimizing the impact on players.

Decoupled Network and Deployment, Greater Optimization Potential for Games: Network and deployment often have different optimization goals. Since they are no longer restricted to the same service provider, they can be optimized separately, helping the game achieve better overall optimization.

Flexible Addition and Removal of Service Providers, Continuous Optimization: The example implementations above do not have a specific limit on the number of service providers. The scheduling module can control traffic, allowing for graceful addition and removal of service provider entrances.

Minimal Impact on Game Deployment: The example implementations above have minimal impact on existing game deployments, requiring little to no modification of game code, making it easy to implement.

ISP Leverage: Leverage diverse network resources across multiple cloud providers and ISPs.

Flexibility and adaptability: Implement more flexible and adaptable traffic routing mechanisms.

Network Optimization: Achieve finer-grained optimization tailored to regional network characteristics. The example implementations above offer more effective performance improvements in specific geographical areas, addressing unique local network challenges that global solutions might overlook.

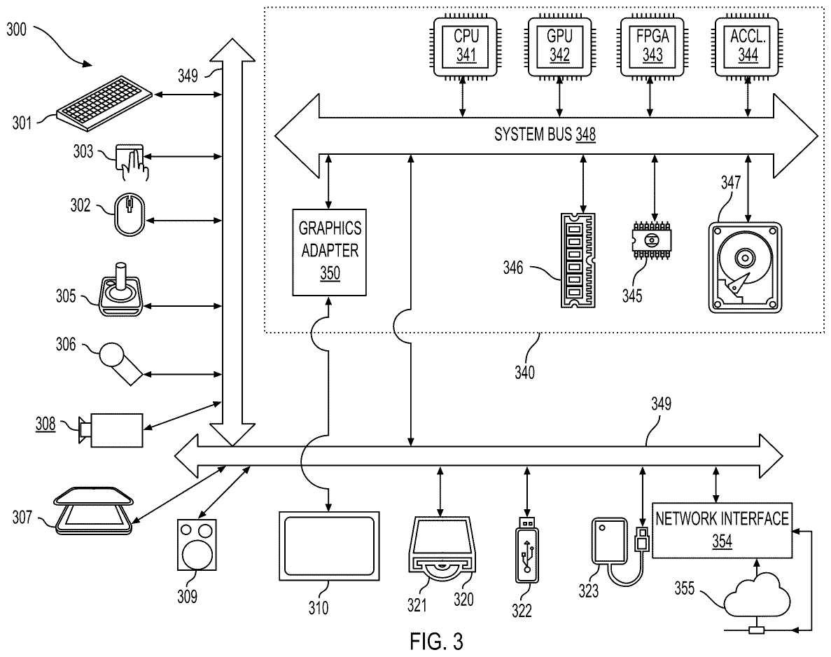

The example scheme described above, may be implemented by the game lobby or other centralized or distributed computers. Each of these computers may be configured with hardware components to execute computer codes to implement the scheme described above. The computer codes may be stored in computer readable media. FIG. 3 shows an example computing component (300).

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 3 for computer system (300) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (300).

Computer system (300) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (301), mouse (302), trackpad (303), touch screen (310), data-glove (not shown), joystick (305), microphone (306), scanner (307), camera (308).

Computer system (300) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (310), data-glove (not shown), or joystick (305), but there can also be tactile feedback devices that do not serve as input devices), audio output devices (such as: speakers (309), headphones (not depicted)), visual output devices (such as screens (310) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (300) can also include human accessible storage devices and their associated media such as optical media including CD/DVD ROM/RW (320) with CD/DVD or the like media (321), thumb-drive (322), removable hard drive or solid state drive (323), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (300) can also include an interface (354) to one or more communication networks (355). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CAN bus, and so forth. Certain networks commonly require external network interface adapters that attached to certain general-purpose data ports or peripheral buses (349) (such as, for example USB ports of the computer system (300)); others are commonly integrated into the core of the computer system (300) by attachment to a system bus as described below (for example Ethernet interface into a PC computer system or cellular network interface into a smartphone computer system). Using any of these networks, computer system (300) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (340) of the computer system (300).

The core (340) can include one or more Central Processing Units (CPU) (341), Graphics Processing Units (GPU) (342), specialized programmable processing units in the form of Field Programmable Gate Areas (FPGA) (343), hardware accelerators for certain tasks (344), graphics adapters (350), and so forth. These devices, along with Read-only memory (ROM) (345), Random-access memory (346), internal mass storage such as internal non-user accessible hard drives, SSDs, and the like (347), may be connected through a system bus (348). In some computer systems, the system bus (348) can be accessible in the form of one or more physical plugs to enable extensions by additional CPUs, GPU, and the like. The peripheral devices can be attached either directly to the core's system bus (348), or through a peripheral bus (349). In an example, the screen (310) can be connected to the graphics adapter (350). Architectures for a peripheral bus include PCI, USB, and the like.

CPUs (341), GPUs (342), FPGAs (343), and accelerators (344) can execute certain instructions that, in combination, can make up the aforementioned computer code. That computer code can be stored in ROM (345) or RAM (346). Transitional data can also be stored in RAM (346), whereas permanent data can be stored for example, in the internal mass storage (347). Fast storage and retrieve to any of the memory devices can be enabled through the use of cache memory, that can be closely associated with one or more CPU (341), GPU (342), mass storage (347), ROM (345), RAM (346), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As a non-limiting example, the computer system having architecture (300), and specifically the core (340) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (340) that are of non-transitory nature, such as core-internal mass storage (347) or ROM (345). The software implementing various embodiments of the present disclosure can be stored in such devices and executed by core (340). A computer-readable medium can include one or more memory devices or chips, according to particular needs. The software can cause the core (340) and specifically the processors therein (including CPU, GPU, FPGA, and the like) to execute particular processes or particular parts of particular processes described herein, including defining data structures stored in RAM (346) and modifying such data structures according to the processes defined by the software. In addition or as an alternative, the computer system can provide functionality as a result of logic hardwired or otherwise embodied in a circuit (for example: accelerator (344)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

A person of ordinary skill in the art may understand that all or some of the steps of the methods in the foregoing embodiments may be implemented by a program instructing relevant hardware. The program may be stored in a non-transitory computer-readable storage medium. The non-transitory computer-readable storage medium may be the computer-readable storage medium included in the memory in the foregoing embodiments, or may be a computer-readable storage medium that exists independently and that is not assembled in a terminal. The non-transitory computer-readable storage medium stores at least one instruction, at least one program, a code set, or an instruction set, and the at least one instruction, the at least one program, the code set, or the instruction set is loaded and executed by the processor to implement the embodiment according to this disclosure.

Optionally, the non-transitory computer-readable storage medium may include: a ROM, a RAM, a solid state drive (SSD), an optical disc, or the like. The RAM may include a resistance random access memory (ReRAM) and a dynamic random access memory (DRAM). The sequence numbers of the foregoing embodiments of this disclosure are merely for description purpose, and are not intended to indicate priorities of the embodiments.

According to an aspect of this application, a computer program product or a computer program is provided, including computer instructions, the computer instructions being stored in a non-transitory computer-readable storage medium. A processor of a computer device reads a computer instruction from a non-transitory computer-readable storage medium, and executes the computer instruction, so that the computer device performs the protein structure information prediction method provided in various optional implementations of the foregoing aspects.

A person of ordinary skill in the art may understand that all or some of the steps of the foregoing embodiments may be implemented by using hardware, or may be implemented by a program instructing relevant hardware. The program may be stored in a non-transitory computer-readable storage medium. The non-transitory storage medium may be a ROM, a magnetic disk, an optical disc, or the like.

The foregoing descriptions are merely exemplary embodiments of this disclosure, but are not intended to limit this application. Any modification, equivalent replacement, improvement, and the like made within the spirit and principle of this application shall fall within the protection scope of this application.

What is claimed is:

1. A method for application hosting and network connection, the method comprising:
receiving a request from a first communication network for an interactive network connection with an application hosted in a second communication network;
selecting, among a plurality of network entry points belonging to the second communication network and one or more third communication networks, an optimal target network entry point for the interactive network connection according to network-probing measurements performed to quantify communication latency between the first communication network and the application in the second communication network via each of the plurality of the network entry points; and
establishing the interactive network connection between the first communication network and the application in the second communication network.

2. The method of claim 1, wherein the first communication network has a network peering relationship with at least one of the third communication networks but has no network peering relationship with the second communication network.

3. The method of claim 1, wherein selecting the optimal target network entry point additionally takes into consideration peering relationship between the first communication network and the one or more third communication networks and between the first communication network and the second communication network.

4. The method of claim 1, wherein a private direct traffic routing path is established between each of the one or more third communication networks and the second communication network.

5. The method of claim 4, wherein the first communication network, the second communication network, and each of the one or more third communication networks are provisioned by separate Internet Service Providers (ISPs).

6. The method of claim 5, wherein the application comprises a multiplayer interactive game.

7. The method of claim 6, wherein:
the method is performed by a game lobby server for the multiplayer interactive game; and
the request is initiated from a game client via the first communication network to the game lobby server.

8. The method of claim 7, further comprising:
generating a list of network addresses of the plurality of network entry points based on a requesting network address associated with the game client in the first communication network;
communicating the list of the network addresses to the game client for the game client to perform the network-probing measurements; and
receiving the network-probing measurements from the game client prior to selecting the optimal target network entry point.

9. The method of claim 7, further comprising:
determining that the game client is not capable of performing the network-probing measurements; and
initiating and performing the network-probing measurements from the second communication network to the first communication network.

10. The method of claim 1, further comprising, after establishing the interactive network connection, continuing probing the communication latency between the first communication network and the application in the second communication network via the plurality of network entry points to determine whether to switch the interactive network connection between the first communication network and the second communication network to a lower latency network entry point other than the optimal target network entry point.

11. A computer server, comprising a memory for storing instructions and at least one processor configured to execute the instructions to:
receive a request from a first communication network for an interactive network connection with an application hosted in a second communication network;
select, among a plurality of network entry points belonging to the second communication network and one or more third communication networks, an optimal target network entry point for the interactive network connection according to network-probing measurements performed to quantify communication latency between the first communication network and the application in the second communication network via each of the plurality of the network entry points; and
establish the interactive network connection between the first communication network and the application in the second communication network.

12. The computer server of claim 11, wherein the first communication network has a network peering relationship with at least one of the third communication networks but has no network peering relationship with the second communication network.

13. The computer server of claim 11, wherein the at least one processor is configured to execute the instructions to select the optimal target network entry point by additionally taking into consideration peering relationship between the first communication network and the one or more third communication networks and between the first communication network and the second communication network.

14. The computer server of claim 11, wherein a private direct traffic routing path is established between each of the one or more third communication networks and the second communication network.

15. The computer server of claim 14, wherein the first communication network, the second communication network, and each of the one or more third communication networks are provisioned by separate Internet Service Providers (ISPs).

16. The computer server of claim 15, wherein the application comprises a multiplayer interactive game.

17. The computer server of claim 16, wherein:
the computer server comprises a game lobby server for the multiplayer interactive game; and
the request is initiated from a game client via the first communication network to the game lobby server.

18. The computer server of claim 17, wherein the at least one processor is further configured to execute the instructions to:
generate a list of network addresses of the plurality of network entry points based on a requesting network address associated with the game client in the first communication network;
communicate the list of the network addresses to the game client for the game client to perform the network-probing measurements; and
receive the network-probing measurements from the game client prior to selecting the optimal target network entry point.

19. The computer server of claim 17, wherein the at least one processor is further configured to execute the instructions to:
determine that the game client is not capable of performing the network-probing measurements; and
initiate and perform the network-probing measurements from the second communication network to the first communication network.

20. The computer server of claim 11, wherein the at least one processor is further configured to execute the instructions to, after establishing the interactive network connection, continuing probing the communication latency between the first communication network and the application in the second communication network via the plurality of network entry points to determine whether to switch the interactive network connection between the first communication network and the second communication network to a lower latency network entry point other than the optimal target network entry point.
